(19) United States
(12) Patent Application Publication
(10) Pub. No.: US 2025/0180794 A1
(43) Pub. Date: Jun. 5, 2025

(54) GLAZING HAVING TOTAL INTERNAL REFLECTION THROUGH IMPROVED LIGHT INJECTION

(71) Applicant: AGP WORLDWIDE OPERATIONS GMBH, Zug (CH)

(72) Inventors: Alexey KRASNOV, Canton, MI (US); Charles Stephen VOELTZEL, Shelby Township, MI (US); Gonzalo Rafael VIZCARRA MENDOZA, Lima (PE); José NUÑEZ-REGUEIRO, Ann Arbor, MI (US); Andrés Fernando SARMIENTO SANTOS, Canton, MI (US); Débora R BARCELLOS DE OLIVEIRA, São José dos Pinhais (BR)

(21) Appl. No.: 18/839,355

(22) PCT Filed: Feb. 16, 2023
(86) PCT No.: PCT/IB2023/051425

§ 371 Date: Aug. 16, 2024

Related U.S. Application Data
(60) Provisional application No. 63/310,934, filed on Feb. 16, 2022.

(51) Int. Cl. F21V 8/00

(52) U.S. Cl. CPC G02B 6/0016; G02B 6/0021; G02B 6/0065; G02B 6/0073; G02B 6/0095

(57) ABSTRACT

The disclosure provides a glazing product designed for ambient lighting in automotive applications. Conventional ambient lighting is achieved by injecting light into the edge of the glazing, which is both inefficient and difficult to package. The present disclosure overcomes these challenges by utilizing a light injection assembly that injects light from one of the large major surfaces of the glazing. The assembly consists of a housing, an optical filler, a light-emitting means, and a cladding, all of which are designed to efficiently inject light into the glazing.

### FIELD OF THE DISCLOSURE

The present disclosure falls in the field of automotive lighting and glazing.

### BACKGROUND OF THE DISCLOSURE

One of the major trends to emerge in the automotive industry over the last decade, the use of LEDs for signaling and lighting in the automotive industry has been a major trend that is rapidly increasing. LED lighting was first introduced in the aftermarket and the early bulbs sold were expensive and often did not emit as much light as the incandescent bulbs they replaced. However, with the global move towards the elimination of incandescent lighting, the LED industry has grown significantly, introducing economies of scale that have reduced the cost of the technology. Additionally, investments in research and development have resulted in improved durability, efficiency, reduced size and much higher light intensity, expanding the use of LEDs from indicators and signals to general illumination.

As a result of the increased durability of LEDs, they are often implemented as a permanent part of the device instead of a replaceable bulb, with many overhead light fixtures having the LEDs permanently attached to the circuit board that handles the LED drivers, controls, and other functions. LEDs now have an estimated lifetime of 50,000 hours, making them more cost-effective and efficient than incandescent bulbs. With these advancements, the use of LED lighting in the automotive industry is expected to continue to grow in popularity.

LED lighting is being used in the automotive industry not only for signaling and ambient lighting but also for headlamps, backup lamps, and task lighting. This helps to reduce energy needed for lighting by up to 80%, improving efficiency and increasing range in fully electric vehicles. LEDs have faster rise time resulting in a substantial reduction in rear-end collisions when used in brake lights. The smaller size of the light emitting portion of headlamps has given designers increased freedom in styling and made it practical to implement headlights that can be steered in the direction of travel.

Innovations in glazing have been made possible by the newer inexpensive, durable, low-cost, thin, and bright LEDs. Automotive glazing has long been used as a platform to provide other functionality including variable light transmission, defrosting, head up displays and antennas. Lighting is now being integrated into automotive glazing and there are a number of new and innovative uses for LEDs with glazing. These advancements have safety benefits and contribute to meeting government regulations for fuel efficiency and emissions while providing environmentally friendly vehicles demanded by the public.

Laminated glazing, such as windshields, are manufactured by bonding two sheets of glass together by means of a thin sheet of clear thermoplastic at an elevated temperature and pressure. It is possible to embed connecting wires and LEDs in the thermoplastic sheet making them a permanent part of the laminate. Laminated automotive glazing with LEDs embedded within the laminate are currently being produced.

In another innovative automotive lighting method, the glazing itself is used to conduct light in a manner similar to that of an optical fiber. Glass fibers have been used to conduct light for many years in communications. The fibers conduct light by bouncing the light of off the walls of the fiber by the principle of total internal reflection.

The same principle can be applied with glazing. Light injected into an edge of the glazing becomes trapped within the glass sheet by the optical principle of Total Internal Reflection, TIR.

There are a number of automotive glazing applications, enabled by the edge injection of LED light, which are based upon total internal reflection. Examples include detection of the status and condition of a windshield surface, a decorative illuminated pattern embedded in a roof, such as those disclosed in document WO 2020201973, and a glazing heating solution accomplished by the injection of infrared (IR) light. In each application, visible or invisible light such as Infrared (IR) light is injected into the glazing at an angle greater than the critical angle of the glass/air interface. At these angles, the light injected into the glass does not refract into the air but, instead, propagates across the glazing while bouncing between the glass surfaces.

To date, light injection has primarily been accomplished by optically coupling the light into the glass from at least one edge of the glazing. This method has been known and in use for many years in non-automotive applications.

Signs printed on a transparent substrate and illuminated by a light source injecting light into one of the edges have been known for decades. The translucent printed graphic on the transparent substrate disperses the light trapped inside of the glass, illuminating the graphic, while the background remains dark. The information on an EXIT sign, as an example, must be viewable under all lighting conditions. The edge injection illumination allows the sign to be seen and highly visible under low lighting conditions without becoming distracting and without the glare or shadows that might occur if conventional lighting were to be used.

In the same manner, edge injection of light into the vehicle glazing can be used to provide ambient cabin illumination. The glass functions as a wave guide for the light. The light is decoupled and refracted by a light dispersing means on the glass surface. Light dispersing surface treatments and materials are known that when applied to glass are substantially invisible when the lighting means is in the off state while providing illumination in the on state. The light dispersing may be patterned to form a graphic.

In the most commonly made illuminated laminate glazing, the inner glass layer is illuminated by a lighting means along at least a portion of the periphery of the glazing and with the light dispersing means deposited on a glass layer major surface interior to the laminate, thereby protecting the dispersing means from wear and damage. Coatings can be applied to the outer glass layers to further improve performance by reflecting incidental light from the dispersing means inboard. An opaque layer, such as a black frit, may also be used to block light from exiting to the exterior of the vehicle. In the same manner, a dark composition of outer glass layer and/or a dark tint plastic interlayer may be used to minimize the amount of light visible from outside of the vehicle. Conversely, the light dispersing means, plastic interlayer and outer glass layer can be designed to maximize visibility from the exterior in order to use the light for signaling.

This type of edge injected illuminated glazing is available as an option on several high-end vehicles, primarily for aesthetics purposes rather than functionality. Although the low level of illumination it provides is sufficient for ambient lighting, it offers the possibility of using multicolor LEDs that can be sequenced to produce an impressive, high-tech aesthetic along with a very unique look and feel.

Implementing LEDs in edge injected illuminated glazing presents several challenges, including limited space for mounting the LEDs and poor optical quality of the glass edge. The need to direct the light into the edge of the glazing requires accommodations in the glazing design to ensure adequate space for the LED attachments. This can be problematic for most vehicle glazing, which typically has minimal clearance between the glass edge and the sheet metal. This limitation often restricts the application of this technology to large, laminated roofs that have black obscuration and mounting frames.

Additionally, the optical quality of the glass edge is often poor. Standard edge treatments like seaming and grinding, while necessary for safety and breakage prevention, produce a rough surface that scatters light and generates a lensing effect. Though it is possible to improve the optical quality of the edge by grinding and polishing it flat, the thinness of the glass layers limits the amount of surface area available for light injection. This is particularly problematic when illuminating only one layer of a multi-layer laminate, as the injection layer may need to be made smaller, resulting in a weakened laminate and increased risk of breakage.

In another similar application, also using the principle of TIR, high intensity infrared light is injected into the glazing at an angle that allows for total internal reflection in the areas of the glazing that are not coated with water or ice taking advantage of the different index of refraction of the different materials. For this type of application, the intensity of the light must be much higher than what is required for illumination. In addition to the problems already cited for edge injection for illumination applications, the inefficiencies can lead to overheating. Also, it is difficult to precisely control the injection angle with edge injection.

An alternate to edge injection of light is disclosed by document DE102020109338 which makes use of a wedge or trapezoidal shaped coupling element to inject light into the interior facing surface of a glazing. However, the device disclosed does not have the capability of precisely controlling the injection angle of the uncollimated light typical of a LED or other point source. The coupling element acts as a prism. However, very little of the light bouncing from wall to wall from a point source enters the glazing at one specific angle or even close to one specific angle. Some of the light also enters the glazing surface without first reflecting off of the prism face. Therefore, applications that rely upon light injection at a precise angle and high injection efficiency, are not suitable for this approach.

It would be desirable to develop a more efficient and more convenient way of injecting the light efficiently and at a precise angle into the glazing.

### BRIEF SUMMARY OF THE DISCLOSURE

In one inventive aspect, the disclosure provides a glazing with a light injection assembly that efficiently injects light into the glazing at a precisely controlled angle using Total Internal Reflection (TIR). The use of carefully selected materials with different IORs and a shaped cavity allows for a more efficient and effective use of light sources such as LEDs.

The present disclosure corresponds to a glazing with an attached light injection assembly that is optically coupled to the glazing. In one specific embodiment, the light injection assembly is made up of a housing that contains at least one cavity with a light emitting means, an optical filler, and cladding. The shape of the cavity is designed to shape the beam of light from an uncollimated point source, such as an LED, and to control the angle of the light that exits the cavity and is injected into the glazing.

The optical filler material fills the cavity and optically couples the light emitting means to the cavity walls or cladding. The housing material can have an index of refraction (IOR) that is less than that of the optical filler. This is achieved by using a material with the desired IOR for the housing or by applying cladding with the appropriate IOR between the optical filler and the housing cavity interior interface.

To ensure total internal reflection (TIR), the materials are carefully selected for the optical filler and the housing or optical filler/cavity interface such that each has an IOR respecting the following condition: n1<n2≥n3, where n1 is the IOR of the housing or cladding, n2 is the IOR of the optical filler, and n3 is the IOR of the glazing. When this condition is met, total internal reflection occurs inside of the cavity, and the light is injected into the glazing efficiently at a precisely controlled angle.

If the optical filler cannot be used to attach the light injection assembly to the glazing surface, an optical adhesive can be used instead. The optical adhesive must have an IOR that is in the same range of n2 and n3, including n2 or n3.

### Advantages

Higher light injection efficiency than conventional edge injection.
Precise control of injection angle.
No change to the size of the glazing is required.
Easier to package.
Easier to manage heat.

### BRIEF DESCRIPTION OF THE DRAWINGS

FIG. 1A corresponds to the cross section of a typical laminated automotive glazing.

FIG. 1B corresponds to the cross section of a typical laminated automotive glazing with performance film and coating.

FIG. 1C corresponds to the cross section of a typical tempered monolithic automotive glazing.

FIG. 2 is a schematic illustrating the principle of Total Internal Reflection.

FIG. 3A is a laminated windshield with camera defroster light injection assembly.

FIG. 3B is a laminated panoramic roof with dual light injection assemblies for ambient illumination.

FIG. 4 is an exploded view of laminated windshield with camera defroster light injection assembly.

FIG. 5 is an exploded view of laminated panoramic roof with dual light injection assemblies for ambient illumination.

FIG. 6A is a side view of light injection assembly.

FIG. 6B is a top view of light injection assembly.

FIG. 7 is an exploded isometric view of light injection assembly.

FIG. 8 is a cross section of laminate with light injection assembly.

FIG. 9 is a cross section of laminate with light injection assembly and lens.

FIG. 10A is a flexible printed circuit with LEDs.

FIG. 10B is a flexible printed circuit with LEDs.

FIG. 11A is a light injection assembly cross section with conical cavity.

FIG. 11B is a light injection assembly cross section with toroidal cavity.

FIG. 12A is a cross section of conical cavity with cladding.

FIG. 12B is an exploded view of light injection assembly with cladding sleeve and optical filler.

### REFERENCE NUMERALS OF DRAWINGS

2 Glass.
4 Bonding/Adhesive layer (plastic Interlayer).
6 Obscuration/Black Paint.
12 Infrared reflecting film.
18 Infrared reflecting coating.
20 Light injection assembly.
22 LED.
24 Lens.
26 Optical adhesive.
28 Optical filler.
30 Material one.
32 Ray one.
34 Angle one.
36 Cavity.
38 Angle of Incidence.
40 Material two.
42 Ray two.
44 Angle two.
46 Major surface normal.
48 Cladding material.
50 Light Injection Housing.
52 Total Internal Reflection.
54 Laminated Glazing.
56 Flexible Printed Circuit.
58 Camera Field of View.
101 Exterior side of outer glass layer 201, number one surface.
102 Interior side of outer glass layer 201, number two surface.
103 Exterior side of inner glass layer 202, number three surface.
104 Interior side of inner glass layer 202, number four surface.
201 Outer glass layer.
202 Inner glass layer.

### DETAILED DESCRIPTION OF THE DISCLOSURE

The present disclosure can be understood by reference to the detailed descriptions, drawings, examples, and claims in this disclosure. However, it is to be understood that this disclosure is not limited to the specific compositions, articles, devices, and methods disclosed unless otherwise specified and as such can, of course, vary.

The following terminology is used to describe the laminated glazing of the disclosure. It is also to be understood that the terminology used herein is for the purpose of describing aspects only and is not intended to be limiting.

The term “glass substrate” or “glass pane” should be understood as a sheet, quantity, or thickness of material, typically of some homogeneous substance. The “glass substrate or pane” may comprise one or more layers. The glass substrate can be, for example, clear float glass or can be tinted or colored glass. The glass substrate can be of any desired dimensions, e.g., length, width, shape, or thickness.

The terms “glass pane” and “laminated glass pane” refer respectively to a glazing having one glass layer and to a laminated glazing having at least two glass layers respectively.

“Laminates”, in general, are products comprised of multiple sheets of thin, relative to their length and width, material, with each thin sheet having two oppositely disposed major faces and typically of a relatively uniform thickness, which are permanently bonded to each other across at least one major face of each sheet.

The term “stack” refers to the arrangement in a pile manner of a plurality of layers. When describing the coating stack, the convention of numbering the coating layers in the order of deposition upon the glass substrate should be used.

The term “glass” can be applied to many organic and inorganic materials, including many that are not transparent. From a scientific standpoint, “glass” is defined as a state of matter comprising a non-crystalline amorphous solid that lacks the long-range ordered molecular structure of true solids. Glasses have the mechanical rigidity of crystals with the random structure of liquids.

The term “glazing” should be understood as a product comprised of at least one layer of a transparent material, preferably glass, which serves to provide for the transmission of light and/or to provide for viewing of the side opposite to the viewer and which is mounted in an opening in a building, vehicle, wall or roof or other framing member or enclosure.

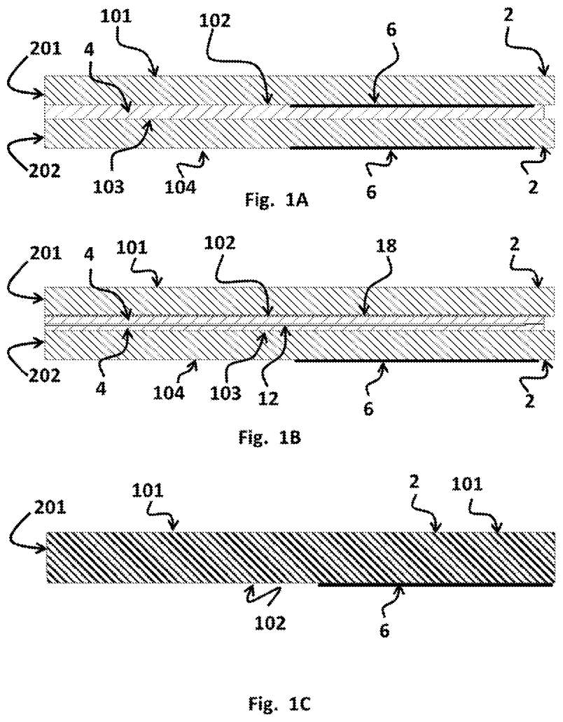

Typical automotive laminated glazing cross sections are illustrated in FIGS. 1A and 1B. A laminate is comprised of two layers of glass, the exterior or outer, 201 and interior or inner, 202 that are permanently bonded together by a plastic layer 4 (interlayer). In a laminate, the glass surface that is on the exterior of the vehicle is referred to as surface one 101, or the number one surface. The opposite face of the exterior glass layer 201 is surface two 102, or the number two surface. The glass 2 surface that is on the interior of the vehicle is referred to as surface four 104, or the number four surface. The opposite face of the interior layer of glass 202 is surface three 103, or the number three surface. Surfaces two 102 and three 103 are bonded together by the plastic layer 4. An obscuration 6 may be also applied to the glass. Obscurations are commonly comprised of black enamel frit printed on either the number two 102, or number four surface 104, or on both. The laminate may have a coating 18 on one or more of the surfaces. The laminate may also comprise a film 12 laminated between at least two plastic layers 4.

FIG. 1C shows a typical tempered automotive glazing cross section. Tempered glazing is typically comprised of a single layer of glass 201 which has been heat strengthened. The glass surface that is on the exterior of the vehicle is referred to as surface one 101 or the number one surface. The opposite face of the exterior glass layer 201 is surface two 102 or the number two surface. The number two surface 102 of a tempered glazing is on the interior of the vehicle. An obscuration 6 may be also applied to the glass. Obscurations are commonly comprised of black enamel frit printed on the number two 102 surface. The glazing may have a coating 18 on the number one 101, and/or number two 102 surfaces.

We shall refer to the large substantially parallel surfaces that comprise the exterior of the glazing as the major surfaces of the glazing. The remainder of the area is substantially comprised by the edge of the glazing.

The structure of the disclosure is described in terms of the layers comprising the glazing. The meaning of “layer,” as used in this context, shall include the common definition of the word: a sheet, quantity, or thickness, of material, typically of some homogeneous substance and one of several.

A typical laminated windshield comprises two glass layers and a plastic interlayer. An interlayer layer is generally of the same area as the glass layers. The typical laminate may further comprise additional layers including but not limited to coatings and films. The surface area of a layer may be substantially less than that of the glazing. A film layer will have a smaller area than the glass. An obscuration layer will have an area that is substantially less than that of the glass.

Other types of materials and components may also be included within the structure. A lighting or heating circuit may be referenced respectively as the lighting layer or the heating layer even though the layer comprises multiple separate components rather than a substantially flat homogeneous sheet of material. In this case, the reference is to the position within the thickness in much the same way that we would reference the floor of a building.

When multiple layers that vary widely in thickness are illustrated, it is not always possible to show the layer thicknesses to scale without losing clarity. Unless otherwise stated in the description, all figures are to be considered as for illustrative purposes and are not drawn to scale and thus shall not be construed as a limitation.

The types of glass that may be used include but are not limited to the common soda-lime variety typical of automotive glazing as well as aluminosilicate, lithium aluminosilicate, borosilicate, glass ceramics, and the various other inorganic solid amorphous compositions which undergo a glass transition and are classified as glass included those that are not transparent. The glass layers may be comprised of heat absorbing glass compositions as well as infrared reflecting and other types of coatings.

Soda-lime glass is made from sodium carbonate (soda), lime (calcium carbonate), dolomite, silicon dioxide (silica), aluminum oxide (alumina), and small quantities of substances added to alter the color and other properties.

Certain types of organic transparent materials are used to produce automotive and other types of glazing which would not, in the common meaning of the word glass, be considered glass. For the purposes of this document, it shall also consider these as glass as the principle of the disclosure can be applied to any transparent substrate.

Laminates, in general, are articles comprised of multiple layers of thin, relative to their length and width, material, with each thin layer having two oppositely disposed major surfaces, typically of uniform thickness, which are permanently bonded to one and other across at least one major surface of each layer. The layers of a laminate may alternately be described as sheets or plies. In addition, the glass layers may also be referred to as panes.

Laminated safety glass is made by bonding two layers of annealed glass together using a plastic bonding layer comprised of a thin sheet of transparent thermoplastic.

The plastic bonding layer (interlayer) has the primary function of bonding the major surfaces of adjacent layers to each other. The material selected is typically a clear thermoset plastic. For automotive use, the most used bonding layer (interlayer) is polyvinyl butyral (PVB). Automotive grade PVB has a refractive index that is matched to soda-lime glass to minimize secondary images caused by reflections at the PVB/Glass interface inside of the laminate.

Windshields are a type of laminated safety glass. Safety glass is glass that conforms to all applicable industry and government regulatory safety requirements for the application. Laminated safety glass is made by bonding two layers of annealed glass together using a plastic bonding layer comprised of a thin sheet of transparent thermo plastic.

Annealed glass is glass that has been slowly cooled from the bending temperature down through the glass transition range. This process relieves any stress left in the glass from the bending process. Annealed glass breaks into large shards with sharp edges. When laminated glass breaks, the shards of broken glass are held together, much like the pieces of a jigsaw puzzle, by the plastic bonding layer helping to maintain the structural integrity of the glass. A vehicle with a broken windshield can still be operated. The plastic bonding layer also helps to prevent penetration by objects striking the laminate from the exterior and in the event of a crash occupant retention is improved.

The disclosure is based up the principle of Total Internal Reflection, TIR, which we will briefly explain. The index of refraction, IOR, of a transparent material is defined as the ratio of the velocity of light (c) in vacuum to the velocity (v) of light in the material/medium.

$$IOR = c / v$$

The index of refraction of a material is typically equal to or greater than one. The more optically dense a material is, the slower light will move through the material.

Refraction occurs when the path of a light beam changes as it travels from one medium to another with a different refractive index. Refraction is caused by the change in the speed of light in the media. The light beam will bend at the interface of the two media/materials. If the light slows down, it will diverge away from the surface normal. If the light speeds up, it will diverge towards the surface normal.

The change in direction is a function of the ratio of the refractive index of the second medium to the first.

When light travels from a medium with a higher refractive index to one with a lower refractive index, the light will refract and exit the denser (higher IOR) medium if the angle of the beam relative to the surface normal is less than the critical angle. If the angle of incidence is equal to or greater than the critical angle, TIR occurs.

The critical angle is the smallest angle of incidence of light travelling in one medium and reaching the interface of an adjacent medium that is optically different (has a different index of refraction) where light suffers total internal reflection. Any light incident to the interface at a smaller angle than the critical angle will refract to the adjacent medium.

If n3 is the refractive index of the glazing and n2 is the refractive index of the adjacent medium in direct contact with it such as in surface one 101 or surface four 104, then the critical angle θ_{c} is calculated by:

$${θ}_{c} = arcsin \frac{{n}_{2}}{{n}_{3}}$$

Using refractive index values of 1 for air, 1.53 for glass, 1.33 for water, 1.30 for ice, and 1.42 for contaminated snow-ice (the average between the index of contaminated snow, 1.525, and that of ice) we get critical angles of:

$$\begin{matrix}{θ}_{glass / air} = 40.81 ° \\ {θ}_{glass / ice} = 58.18 ° \\ {θ}_{glass / water} = 60.63 ° \\ {θ}_{glass / snow - ice} = 68.14 °\end{matrix}$$

It should be noted that the example indices and critical angles given may vary depending on the type of glass and other factors.

It can be seen that the critical angle at which TIR occurs varies over a wide range depending upon the surface condition (interface between media) and the light injection angle.

When TIR occurs, any substance present on the surface will frustrate TIR, allowing the light to exit the substrate, if the substance has a refractive index that results in a critical angle that is greater than the angle of incidence of the internal light. This is the principle that the disclosure is based upon.

This is also the principle upon which optical fibers work. A glass fiber is clad in a transparent material with a low index of refraction resulting in total internal reflection at even very low angles. Not only does total internal reflection allow a single fiber cable to conduct light over a great distance, by varying the angle of incidence of the beam entering the fiber, up to 3,000 different separate beams can be simultaneously carried over the same multimode fiber.

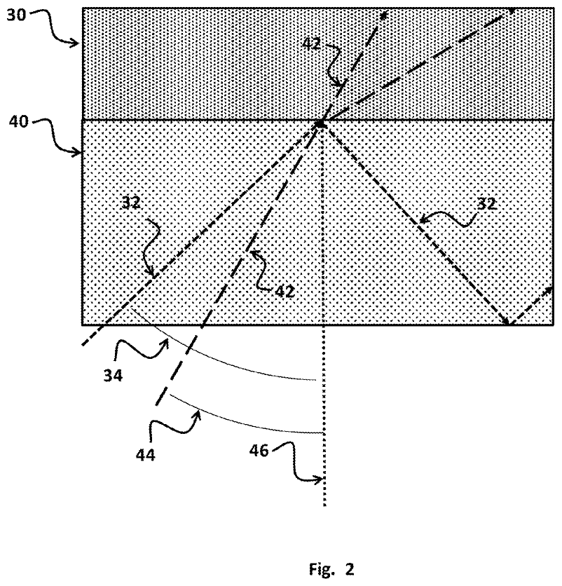

The principle is illustrated by FIG. 2. Two rays of light, ray one 32 and ray two 42 enter material one 40. Material two 30 has a refractive index of n1 and material one 40 has a refractive index of n2. Ray two 42 enters at angle two 44, which is less than the critical angle, and passes through material one 40 into material two 30. Ray one 32 enters at angle 34, which is equal to the critical angle, and is reflected and trapped within material one 40.

While the focus of the embodiments and discussion of this disclosure is laminated automotive windshields and roofs, it can be appreciated that the disclosure is not limited to laminated automotive windshields and roofs. The disclosure may be implemented with monolithic glazing as well as any of the other glazing positions in the vehicle. In the same manner, the disclosure may be implemented in any type of glazing including glazing that is not used in a vehicle such as in commercial, military, marine, rail, aerospace, and other vehicles as well as in stationary applications such as building windows, doors, and partitions. Further, the disclosure maybe used to inject light into any transparent material with parallel surfaces.

In addition, the substrate does not need to be inorganic glass. Any transparent material, including organic, can potentially be used depending upon the optical properties of the material. For illumination purposes, the organic glass could have its scattering particles embedded in the glass itself.

Likewise, it should be noted that other lighting emitting means may be used in place of the LEDs of the described embodiments of this disclosure without departing from the concept of the disclosure. Any means that can provide the intensity and meet the packaging requirements may be utilized including but not limited to incandescent, halogen, fiber optics, light pipes, Light-emitting diodes (LEDs), Compact fluorescent lamps (CFLs), Neon lights, Electroluminescent wire (EL wire), Laser diodes, Phosphorescent materials, Photoluminescent materials, OLEDs (organic light-emitting diodes), Quantum dots, Electrochromic materials, Liquid crystal displays (LCDs), Gas-discharge lamps, Arc lamps, Fluorescent tubes, Tungsten-halogen lamps, Metal-halide lamps, and the like, or even means not yet invented. Further, any combination may be used.

The lighting means may comprise a light source located separate from the light injection assembly and delivered by means of a waveguide. In the present disclosure, it shall consider all of these as lighting emitting means regardless of the type of light source and method of delivery as equivalent.

The type of light emitted by the light emitting means of the disclosure includes but is not limited to collimated, uncollimated, white, monochromatic, infra-red, multi-wavelength light or any combination depending upon the application.

In accordance with the present disclosure, the term “inject” is defined as the process of introducing light into a glazing material which serves as a waveguide for the light. The light injection means must be designed to direct the light at a specific angle or range of angles to efficiently inject light into the glazing. The light injection assembly may be integrated and combined with a molding, frame, housing, bracket, encapsulation, or trim as a single unit.

In accordance to the present disclosure, the term “angle of injection” refers to the theoretical angle that a perfect single ray traveling through a perfect optical path would form in relation to the major surface normal. In practical applications, it should be appreciated that the actual angle of injection may vary, and not all photons will be present at the exact desired angle. However, a significant number of photons will be present within an acceptable tolerance range, within TIR will occur.

Embodiments of the present disclosure described herein provide an angle of the injected light to be greater than the critical angle for TIR to occur. This critical angle is the smallest angle of incidence at which total internal reflection to occur. This critical angle is the smallest angle of incidence at which TIR happens and is a function of the refractive index of the two media that the light passes through. In the case of soda-lime glass and air, the critical angle is 40.81 degrees.

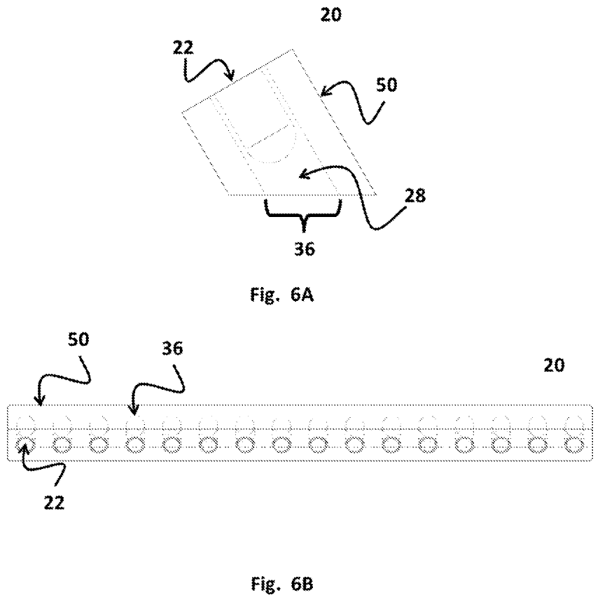

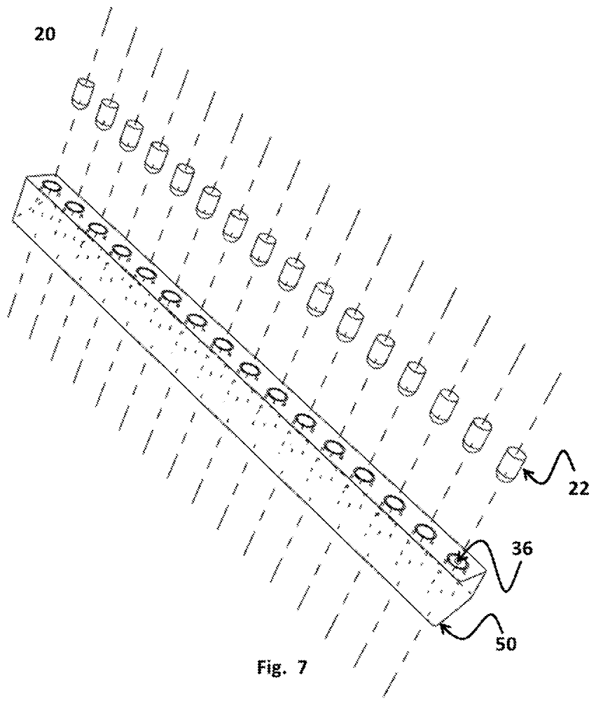

FIGS. 6A, 6B and 7 depict various views of the light injection assembly, which comprises a housing 50 that conforms to the shape of the glazing surface to which it will be mounted. The mounting face of the housing 50 that is part of the light injection assembly 20, is designed to enable the injection of light into the glazing, with precise control of the angle of the light beam. Furthermore, the number and configuration of the light injection assemblies could also be modified depending on the application or desired lighting effect. Additionally, the shape, size, or materials of the housing, cavities, or lenses could be changed to optimize the light output.

The housing 50 includes at least one cavity 36 in which the light emitting means are installed. The internal cavities and the housing 50 are designed to direct the light at a specific angle into the glazing. The angle between the surface of the attachment and the LED axis is selected to ensure that light is injected into the glazing at desired angles, typically greater than the critical angle of the interface between the glazing and the external environment (air, water, fog, ice-snow).

Each cavity/light emitting means can be set at the same or different injection angles. The cavity 36 may be a through or partial hole, with one portion of the cavity opening to the glazing surface to which the assembly is mounted. In the case of a through hole, the light source element may inject light from one end of the cavity, with the light exiting to the glazing at the other end of the cavity. This enables easy replacement of the light source element for maintenance purposes.

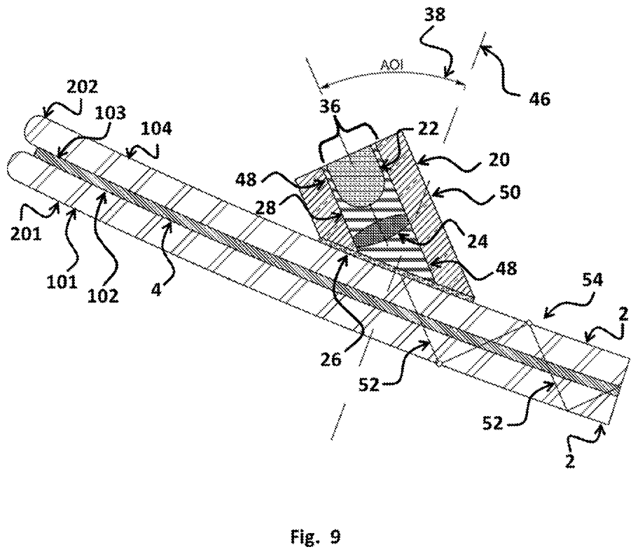

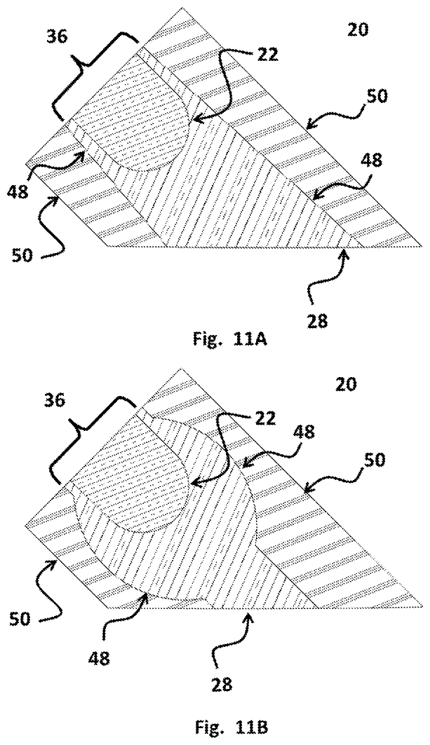

The shape of the cavity 36 is designed to focus and direct the uncollimated light from the LED die, which acts as a point source emitting in all directions, towards the end of the cavity optically bonded to the glazing. The orientation of the cavity relative to the glazing surface is set to ensure that the light is injected at the precise angle. The cavity 36 shape may include but is not limited to cylindrical (FIG. 9), toroidal/spherical (FIG. 11B), parabolic or conical (FIG. 11B) shape and may be equipped with additional features as needed, such as a groove for locking an LED 22 or lens 24 into place.

The light beam can be controlled and shaped by the index of refraction of the cavity 36 and the clear optical filling as well as by the ratio of the shape and dimensions of the cavity and opening.

One or more cavities 36 may be equipped with at least one lens 24 to provide additional collimation as shown in FIG. 9. The cavities are filled with a clear optical filler 28, and the material adjacent to the optical filler and the interior of the housing cavity (cladding material) must have an IOR, n1, that is less than that of the optical filler, n2. This is essential to ensure that each opening collimates the light, sending it to a preferential cone of desired injection angles by the total internal reflection within each opening. The light beam can be controlled and shaped by the index of refraction of the cavity 36 and the clear optical filling, as well as by the ratio of the shape and dimensions of the cavity and opening.

An analogy of the light coming from the elongated opening with a TIR vs the light injected just by shining an LED at the edge is like a bullet running through the barrel of a rifle instead of an unguided bullet exiting the cartridge.

There are various means to satisfy can be used to satisfy the condition n1<n2. One option is to use the housing made of a transparent material with an IOR of n1 which is lower than n2. However, this approach limits the materials that can be used. A more practical approach is to apply a coating or cladding made of a material with an IOR of n1, to the interior surface of the cavity, or to the optical filler itself. In some other cases, it may be advantageous to use a sleeve made of the n1 cladding material, which is inserted into the cavity, and then the optical filler is inserted into the sleeve. Regardless of the approach, in one embodiment, the cladding is optically coupled to both the optical filler and the lighting means.

It should be noted that the decoupling of light can be achieved through a combination of reflection, refraction, and diffraction mechanisms on any of the surfaces of the glass layers, or by means of a separate element placed on the glass layer. The outcoupling mechanisms may also be based on various principles, including but not limited to holographic or waveguide principles, special inks or similar to enable precise control over the direction and intensity of the light.

The optical filler 28 may be implemented in several ways. For instance, the cavity 36 may be filled with a liquid material that is cured, or it can be formed through a molding process and then inserted into the housing. Alternatively, the housing 50 can be molded and formed around the optical filler. The material may be cured using UV, a catalyst, air, heat, moisture or a combination of these or other means.

The n1 cladding material 48 serves the same function as the cladding in an optical fiber, forming the interface between the optical filler and the walls of the housing cavity. It was surprisingly discovered that if the housing 50 is made of a material with an IOR of n1, the housing material itself serves as the cladding material 48.

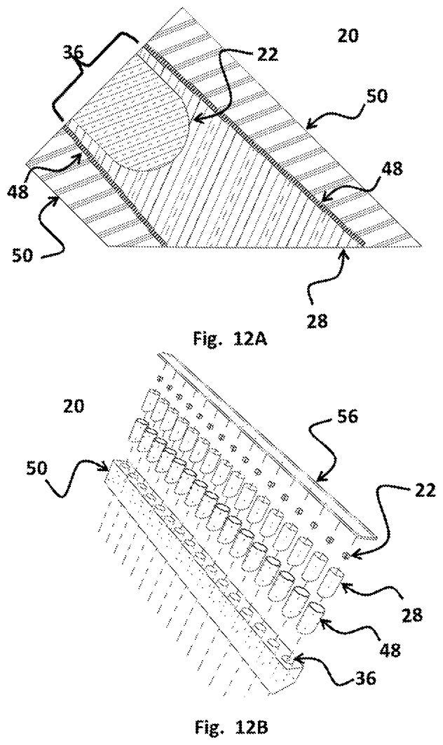

FIG. 12A shows a cross section of a cavity 36 with a cladding material 48 between the optical filler 28 and the housing 50. In FIG. 12B, it can be seen an exploded view of a light injection assembly with sixteen LED dies mounted on a flexible printed circuit 56, wherein the dies 22 are encapsulated in the optical filler material 28, which is inserted into cladding 48 sleeves which are inserted into the cavities 36 of the housing 50.

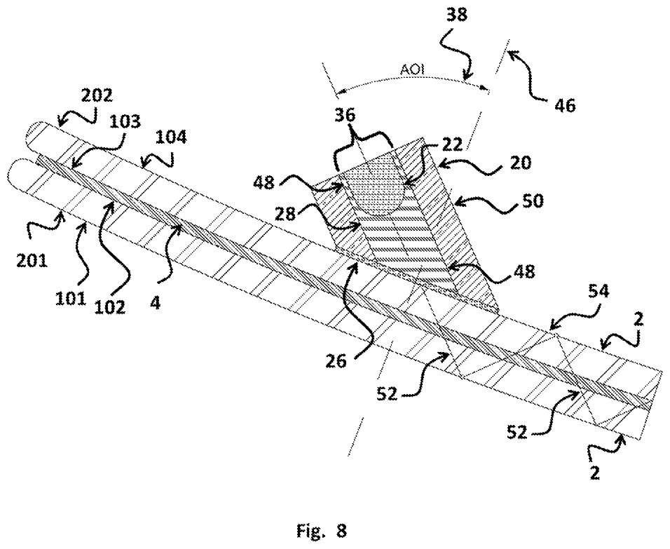

Cross sections of light injection assemblies are shown in FIGS. 8, 9, 11A and 11B, where the housing 50 itself is made of a transparent material with an IOR of n1. In this case, the wall of the housing cavity serves as the cladding 48 and a separate component is not required.

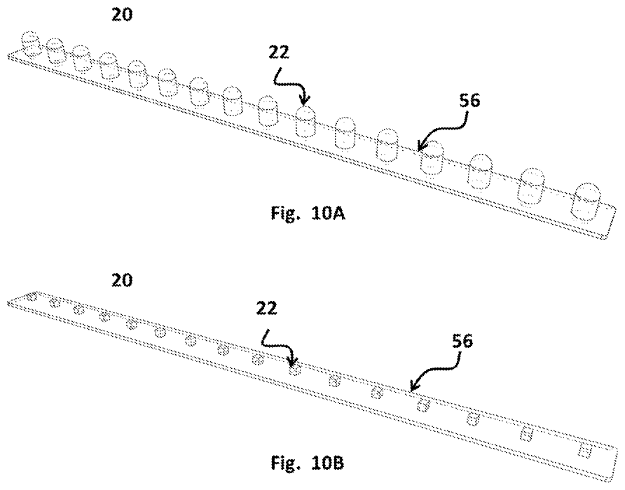

While typical circuit board mount LEDs 22 are shown in some of the figures, wherein the LED die are encapsulated in a plastic housing, bare LED dies may also be used. In either case, the LEDs 22 may be mounted to a flexible printed circuit board 56 as shown in FIGS. 10A, 10B and 12B and affixed to the housing 50.

To ensure minimize optical losses between the mounting surface of the glazing and the light injection assembly, it is important to use an appropriate optical adhesive 26 to attach the assembly to the glazing. The adhesive 26 should have a that falls between the values of refractive indexes of the optical filler, n2, and the glazing, n3. In additional embodiments, it is also recommended to match the optically clear optical filler 28 and the optically clear adhesive 26 to the refractive index of the glass substrate, n3, that the light injection assembly 20 is mounted on. This will ensure that the interface between the assembly and the glazing is optically efficient, and the maximum amount of light is injected into the glazing.

### Examples

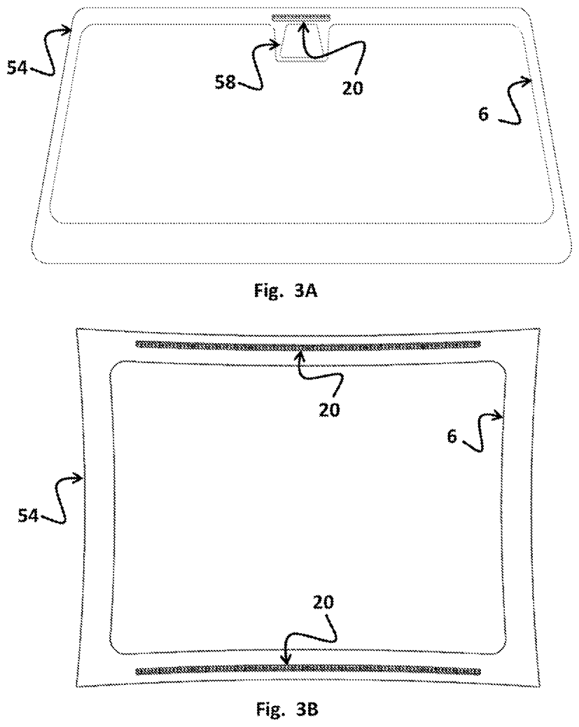

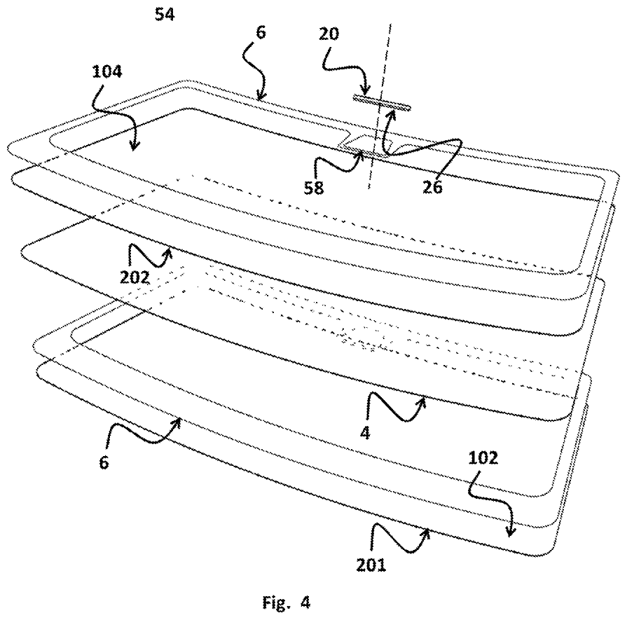

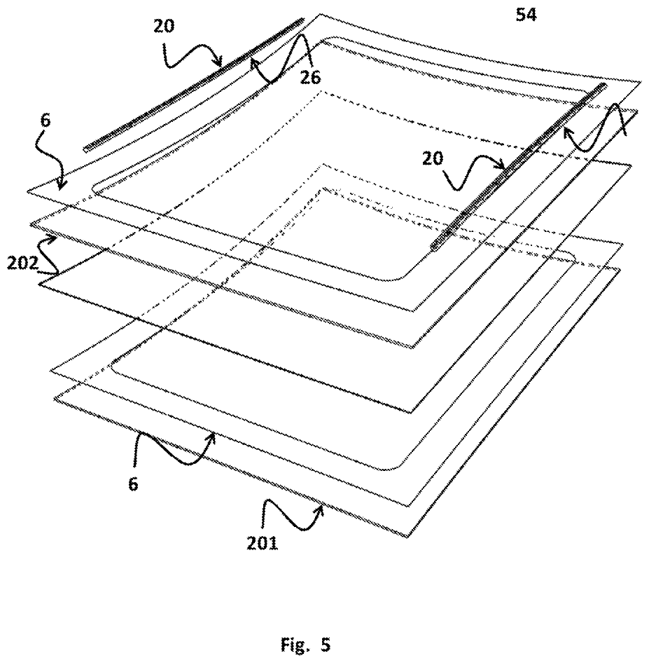

1. Embodiment 1 features a laminated windshield 54, illustrated in FIGS. 3A and 4, with a center line height of 800 mm and a width of 1200 mm. The windshield comprises an inner glass layer 202 made of ultra-clear low iron soda-lime glass, which is 2.3 mm thick and an outer glass layer 201 made of solar green soda-lime glass. The two glass layers are laminated together using a PVB interlayer 4 that is 0.76 mm thick. Surfaces two 102 and four 104 have a black enamel frit obscuration 6 is printed on them. The vehicle that the windshield is used in has a camera-based driver aid system that looks out through a field of view 58 at the top center of the windshield where the opening in the black obscuration can be seen.
   For the single light injection assembly 20 shown in FIGS. 3A, 4 and 6B, an array of sixteen cylindrical cavities 36 are installed just above the camera field of view 58. Each cavity has a single 2-watt infra-red LED 22. The light from the LEDs is injected into the number four surface 104 of the glazing on which the light injection assembly 20 is mounted. The housing 50 of the assembly is made of machined aluminum for efficient heat dissipation. The housing 50 has cylindrical through hole cavities 26 with a diameter of 8.0 mm, as shown in FIG. 12B. The LED 22 dies are mounted on a flexible circuit board 56 which is bonded to the top face of the housing 50, as shown in FIG. 10B.
   Prior to assembly to the housing 50, the LED 22 dies are encapsulated with a transparent thermo-plastic cladding material 48 having an IOR matched (within 5%) to that of the soda-lime glass 202 of the light injection assembly 20. A thin layer liquid resin cladding material, with an IOR of 1.3, is applied to the optical filler encapsulated LED die and then inserted into the housing 50.
   The light injection assembly 20 is optically coupled to the surface four 104 of the glazing using an optically clear adhesive 26 that is index matched (within 5%) to the glass. The incident angle of the light, relative to the major surface normal 46, shown in FIG. 2, is between 60.63 and 68.14 degrees. The injected light is trapped inside of the glazing. Different embodiments of the materials or features described could include using different types of glass or interlayer materials, modifying the shape or size of the light injection assembly, or altering the incident angle of the light for different applications.
2. Embodiment 2 features a laminated roof 54, as shown in FIGS. 3B and 5, that measures 1000 mm in width and 1400 mm in length. The inner glass layer 202 is made of ultra-clear low iron 2.3 mm thick soda-lime glass, while the outer glass layer 201 is 3 mm solar green soda-lime glass. The two glass layer are laminated together using a 0.76 mm thick grey PVB interlayer 4, which has a total visible light transmission of 20%. A black enamel frit obscuration 6 is printed on surfaces two 102 and four 104. The black obscuration 6 on surface four 104 features openings that expose the glass surface where the light injection assemblies 20 will be attached.
   To provide illumination, a set of five light injection assemblies are installed along both fore-art edges. Each assembly contains an array of sixteen cavities, each with a single 1-watt, three color, RGB, LED. The outboard edge of the assembly is positioned 40 mm inboard from the edge of glass, providing clearance for the mounting flange of the body opening and interior trim. This arrangement also allows the edge of the glass to extend to the edge of the roof, which is not possible with edge injected light.
   The housings of the light injection assemblies are made of a thermoplastic, and each cavity is coated with a cladding material with an IOR of 1.3. The shape of the cavity is conical with an opening on the side opposite the major glass face of 8 mm as shown in FIG. 12A.
   The light is coupled into surface four 104 of the glazing on which the light injection assembly is mounted. The housing of the assembly has cylindrical through hole cavities with a diameter of 6.35 mm. Further, each cavity 36 is equipped with a lens 24 to further culminate and focus the beam (similar as the one depicted in FIG. 9). The LED 22 dies, shown in FIG. 10B, are mounted to a flexible circuit board 56 which is bonded to the top face of the housing 50.
   The light injection assembly 20 is optically coupled to the surface four 104 of the glazing by means of an optically clear adhesive 26 index matched to the glass. The incident angle of the light, relative to the major surface normal 46 (from FIG. 2) is 60 degrees. The light is outcoupled by a surface treatment, which forms a graphic pattern, printed on surface three 103.
   It should be emphasized that for both the present embodiment and the disclosure described herein, the decoupling of light can be achieved through a combination of reflection, refraction, and diffraction mechanisms on any of the surfaces of the glass layers, or by means of a separate element placed on the glass layer. The outcoupling mechanisms may also be based on various principles, including but not limited to holographic or waveguide principles, special inks or similar to enable precise control over the direction and intensity of the light.
3 Embodiment 3: is the same as embodiment one except for the cavity shape. Rather than having a cylindrical shape, the cavity is conical as shown in FIG. 11A.
4 Embodiment 4: is the same as embodiment two except for the cavity shape. Rather than having a cylindrical shape, the cavity is conical as shown in FIG. 11A.
5 Embodiment 5: is the same as embodiment one except for the cavity shape. Rather than having a cylindrical shape, the cavity is spherical as shown in FIG. 11B.
6 Embodiment 6: is the same as embodiment two except for the cavity shape. Rather than having a cylindrical shape, the cavity is spherical as shown in FIG. 11B.
7 Embodiment 7: comprises the laminated roof of embodiment two and is the same in all respects other than the cladding of the cavities and the light injection housing material. The housings of the light injection assembly are made of a transparent thermoplastic with an IOR of 1.3. Thus, the interior surface of the housing serves as the cladding without the need to add another material.
8 Embodiment 8: comprises the laminated roof of embodiment two and is the same in all respects other than the optically clear adhesive 26 that is not used. Instead, the optical filler comprises a material that has good adhesion to the glazing.
9 Embodiment 9: comprises the laminated windshield or roof of any one of the previous embodiments with the addition of a protective element (not shown in the Figures) such as a casting resin (encapsulation means) or cover placed around the light assembly with the purpose of either environmental protection or means for attachment to the glazing or a combination of both.

It must be understood that the present disclosure is not limited to the embodiments described and illustrated, as it will be obvious for an expert on the art, there are different variations and possible modifications that do not strive away from the disclosure's essence, which is only defined by the following claims.

1. An automative glazing for improved light injection and total internal reflection, comprising:
at least one transparent layer with two major surfaces and an edge, wherein the transparent layer has an index of refraction of n3; and
at least one light injection assembly in contact with at least a part of one of the major surfaces of the at least one transparent layer, the at least one light injection assembly comprises:
a housing with at least one cavity, wherein a portion of said at least one cavity opens to said first transparent layer;
an optical filler having an index of refraction of n2, which substantially fills said at least one cavity;
a light emitting means mounted to emit light within said at least one cavity;
wherein said light emitted into said cavity is shaped by the cavity and directed at a specific angle relative to said at least one transparent layer;
wherein the at least one light injection assembly includes a cladding with an index of refraction of n1 that is adjacent and optically coupled to the optical filler, with n1<n2≥n3; and
wherein said at least one light injection assembly is affixed to the at least one major surface of the at least one transparent layer and is configured to inject light from the optical filler to the glazing surface at an angle that is less than the critical angle calculated for the interface between the optical filler the at least one transparent layer.

2. The glazing of claim 1, further comprises an optical clear adhesive wherein:
said optical adhesive optically couples one major surface of the at least one transparent layer with the light injection assembly; and
said optical adhesive has an index of refraction the less than or equal to n2 and greater than or equal to n3.

3. The glazing of claim 2, wherein the optical adhesive index of refraction matches the index of refraction of said at least one transparent layer n3.

4. The glazing of claim 1, wherein said cavity comprises a through hole.

5. The glazing of claim 1, wherein said cavity has a shape selected from the group comprising: cylindrical, spherical, toroidal, parabolic, conical or the combination thereof.

6. The glazing of claim 1, wherein at least one cavity is equipped with at least one lens.

7. The glazing of claim 1, wherein the light emitting means are individually addressed electrically.

8. The glazing of claim 1, wherein the light emitting means emit at least two frequencies.

9. The glazing of claim 1, wherein the cladding is a sleeve.

10. The glazing of claim 1, wherein the cladding is a coating.

11. The glazing of claim 1, wherein the housing material serves as the cladding.

12. The glazing of claim 1, wherein the light emitting means is surrounded by the optical filler.

13. The glazing of claim 1, wherein the optical filler comprises a material with adhesive properties.

14. The glazing of claim 1, further comprising a protective element around the assembly for environmental protection.
